(19) United States
(12) Patent Application Publication
(10) Pub. No.: US 2012/0050225 A1
(43) Pub. Date: Mar. 1, 2012

(54) INTEGRATED TOUCH PANEL WITH ANTI-ELECTROMANETIC INTERFERENCE CAPABILITY

(76) Inventors: SHIH-LIANG CHOU, Yang-Mei Jen (TW); Hsueh-Chih Chiang, Yang-Mei Jen (TW); Chien-Min Weng, Yang-Mei Jen (TW); Jyh-An Chen, Yang-Mei Jen (TW); Shr-Lung Chen, Yang-Mei Jen (TW); I-Wen Lee, Chung Li City (TW); Hsing-Yeh Chen, Chung Li City (TW)

(21) Appl. No.: 12/964,800

(22) Filed: Dec. 10, 2010

Related U.S. Application Data
(63) Continuation-in-part of application No. 12/870,063, filed on Aug. 27, 2010.

(51) Int. Cl. G06F 3/042; G06F 3/041

(52) U.S. Cl. 345/175; 345/176

(57) ABSTRACT

A touch panel includes a transparent substrate, an electrically conductive icon or artwork layer, a first icon or artwork layer, a sensing layer, a metal layout and an electrode pattern. The electrically conductive icon or artwork layer is disposed between the transparent substrate and the first icon or artwork layer. The first icon or artwork layer is so coated as to extend over the periphery of the electrically conductive icon or artwork layer. The electrically conductive icon or artwork layer is electrically connected to a grounding trace to impart the touch panel an improved anti-electromagnetic interference capability, thereby ameliorating the problem of false actuation that frequently occurs between the icon or artwork layer and the sensing layer in the conventional devices.

### CROSS-REFERENCE TO RELATED APPLICATION

This application is a continuation-in-part of U.S. Ser. No. 12/870,063 filed on Aug. 27, 2010, entitled “Integrated Touch Panel and Manufacturing Method thereof,” the disclosure of which is incorporated herein by reference in its entirety.

### BACKGROUND OF THE INVENTION

1. Field of the Invention

The present invention relates to the touch panel technology, to a touch panel with anti-electromagnetic interference capability.

2. Description of the Prior Art

There are some common types of touch panels, i.e., the resistive panel, capacitive panel, surface acoustic wave panel, optical (infrared) panel etc. Among these, the most commonly used are the resistive panels, followed by the capacitive panels. The capacitive panels are further divided into 2 types, projected capacitive and surface capacitive. The advantages of the capacitive panels are waterproofing and scratch-proofing, and they have high light transmittance and broad temperature range. Therefore, the panels come at a high price. With the advancement of technology, however, the capacitive panels are beginning to gain a share in the market of small monitors.

The outermost surface of the conventional touch panel, which comes to contact with the environment, is usually made of a chemical-tempered cover glass substrate. This outermost cover substrate is then laminated to the sensing layer, which usually uses indium tin oxide (ITO) as its conductance. Integrating this combination with the display panel produces a complete touch screen. The sensing layer is employed to establish a uniform electrostatic field across the glass substrate. Touch control is accomplished by sensing a slight change in the electric current caused by a human touch, such as by a finger touch.

The conventional touch panel described above presents the following drawbacks:

1. Since the conventional touch panel is designed to detect the location of a touch by sensing a change in electrostatic field across the glass substrate, the precision of the detection may remarkably decrease in the presence of electromagnetic interference (EMI).

2. In the past, the cover glass substrate and the sensing layer described above are laminated with optically clear adhesive (OCA). Other than that, an additional black icon or artwork layer is printed on the peripheries of the cover glass substrate to shield the circuits. The conventional icon or artwork layer is printed on the cover glass substrate perpendicularly and this will usually cause unsatisfactory results when laminating the substrate to the sensing layer; incomplete or uneven cladding may occur.

3. The uneven slots produced during the etching of sensing circuits on the ITO sensing layers will compromise the quality of the images on the display and reduce its yield rate.

4. In the conventional touch panels, the electrode pattern is usually laminated on the sensing layers and this would increase the overall thickness of the panel. This is against the current market trend that prefers thin and slim products. The cost required to maintain a better yield is also higher.

### SUMMARY OF THE INVENTION

Accordingly, an object of invention is to provide a touch panel with anti-electromagnetic interference capability.

In order to achieve the object described above, the touch panel according to the invention includes a transparent substrate, an electrically conductive icon or artwork layer, a first icon or artwork layer, a sensing layer, a metal layout and an electrode pattern. The electrically conductive icon or artwork layer is disposed between the transparent substrate and the first icon or artwork layer. The first icon or artwork layer is so coated as to extend over the periphery of the electrically conductive icon or artwork layer. The sensing layer is superimposed on and juxtaposed to the first icon or artwork layer and areas of the transparent substrate uncovered by the first icon or artwork layer. The metal layout is coated on an outer periphery of the sensing layer in corresponding to the mapping location of the first icon or artwork layer. The electrode pattern is disposed in a manner corresponding to the mapping location of the first icon or artwork layer and opposite to the position of the metal layout. The electrically conductive icon or artwork layer serves to provide shielding from the ambient electromagnetic fields and further functions as a grounded conductor. By virtue of this arrangement, the touch panel may perform its function without being affected by the electromagnetic interference from neighboring equipments, thereby ensuring a stable transmission of touch signals.

Another object of the invention is to eliminate the conventional step of laminating the transparent substrate and sensing layer with an optically clear adhesive. According to the invention, the inner periphery of the first icon or artwork layer is arranged not perpendicular to the adjacent line of the transparent substrate, so that complete cladding of the optical film or sensing layer can be done via sputtering. The yield of the structure is thus raised. The coating, printing or spraying of the electrode pattern directly on the sensing layer also effectively causes the overall thickness of the panel reduced and the yield rate improved.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is an exploded diagram of the touch panel according to the first preferred embodiment of the invention;

FIG. 2 is a structural schematic diagram of the touch panel according to the first preferred embodiment of the invention;

FIG. 3 is a structural schematic diagram illustrating the touch panel according to the second preferred embodiment of the invention, which additionally includes a passivation layer;

FIG. 4 is a structural schematic diagram of the touch panel according to the third preferred embodiment of the invention;

FIG. 5 is a structural schematic diagram of the touch panel according to the fourth preferred embodiment of the invention; and

FIG. 6 is a structural schematic diagram of the touch panel according to the fifth preferred embodiment of the invention.

### DETAILED DESCRIPTION OF THE PREFERRED EMBODIMENTS

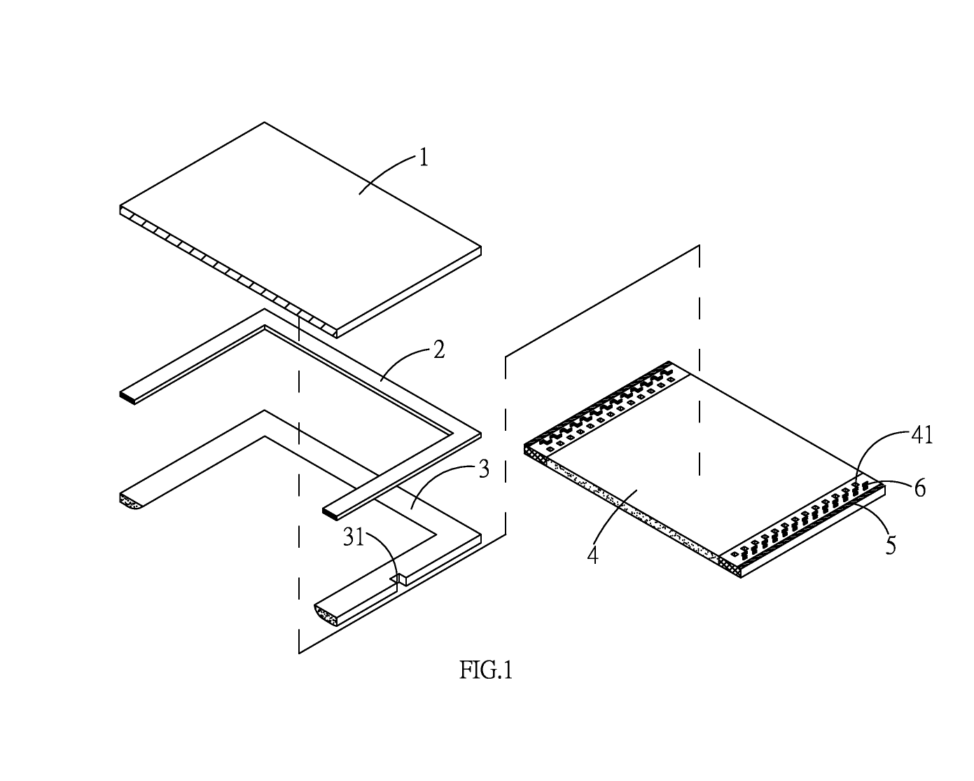

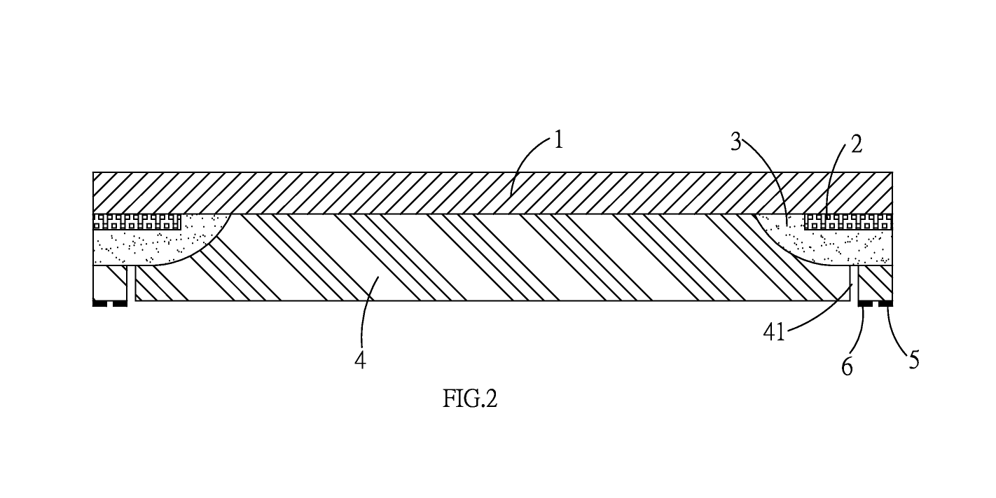

The touch panel according to the first preferred embodiment of the invention is illustrated in FIGS. 1 and 2. First of all, when manufacturing the touch panel, the entire manufacturing process is controlled at a temperature below 200° C. The diagrams show the structure of the touch panel. Combining a display panel (not shown) with it will create a complete panel. It is mainly a surface capacitive touch panel. The touch panel comprises a transparent substrate 1, an electrically conductive icon or artwork layer 2, a first icon or artwork layer 3, a sensing layer 4, a metal layout 5, and an electrode pattern 6.

The transparent substrate 1 is the outermost surface of the touch panel that directly comes to contact with the environment. Therefore, it is strengthened to protect it from scratch and other damages. The transparent substrate 1 may either be made of glass or polymer plastic. If glass is used as its material, the glass is first cut into several small pieces where the thickness of each is about 0.5-3.5 mm. These small pieces are then chemically-tempered by dipping them in potassium nitrate solution or other chemical solutions.

The electrically conductive icon or artwork layer 2 mainly serves to provide shielding from the ambient electromagnetic fields and also functions as a grounded conductor. The electrically conductive icon or artwork layer 2 may be provided by coating a layer of electrically conductive carbon ink onto the periphery of one side face of the transparent substrate 1. Alternatively, it can be fabricated by deposition of a layer of transparent conductive material (such as ITO) followed by an etching process to form an icon at the edges of the touch panel.

The first icon or artwork layer 3 mainly functions as a shield to cover up the signal conducting wires at the edges of the touch panel. To do that, ink prints of about 2˜15 μm thick are coated on the periphery of one side face of the transparent substrate 1. Also, the inner periphery of the first icon or artwork layer 3 is not perpendicular to the adjacent line of the transparent substrate 1 so that the cladding of the subsequent structures can be complete. In order to control the screen printings so that they are formed at a non-perpendicular angle, the below parameters may by way of example be used: ink with a viscosity of 10˜300 dPa·s, the screen conditioned at 50˜400 mesh tetron screen, and the tension at minimum 15 Newton force.

The sensing layer 4 is made of conductive materials like the ITO transparent conductive film with a thickness of 10˜100 nm. This layer is stacked on the icon or artwork layer 3 and the areas of the transparent substrate 1 uncoated with the first icon or artwork layer 3. This can be done using vacuum DC and RF magnetron sputtering deposition technique. Optionally, alternative methods like layer-by-layer sputtering, spray pyrolysis, pulsed laser deposition, arc discharge ion plating, reactive evaporation, ion beam sputtering, or chemical vapor deposition (CVD) etc. can be used.

The function of the metal layout 5 is to provide voltage so that a steady electric field distribution is created within the touch panel. It is usually made of silver and printed on the ITO. The metal layout 5 is placed at the outermost periphery of the sensing layer 4, corresponding to the mapping location of the first icon or artwork layer 3. This location allowed the silver lines to be covered by the first icon or artwork layer 3 and shielded from sight after the final assembly of the panel is completed. The outlook of the panel is thus not affected.

The electrode pattern 6 is placed at the inner periphery of the first icon or artwork layer 3 opposite to the location of the metal layout 5, and formed via direct coating, printing, or spraying on the first icon or artwork layer 3. As the electrode pattern 6 is directly formed on top of the sensing layer 4, the overall thickness of the panel can be reduced, the quality controlled, and the yield rate improved. In order to produce an even distribution of electric field lines in the touch panel, several slots 41 are etched at the inner most periphery of the sensing layer 4, corresponding to the mapping location of the first icon or artwork layer 3 and the opposite location of the electrode pattern 6. With the metal layout 5, electrode pattern 6, and slots 41, the electric field distribution made of several X axis or Y axis is created in the touch areas of the touch panel. When the user touches the panel, touch signals are produced in the control circuits and transmitted to a host computer so that the touch orders and locations can be determined.

The metal layout 5 comprises a grounding trace (not shown), and the first icon or artwork layer 3 is formed with a notch 31 in corresponding to the electrically conductive icon or artwork layer 2 and the grounding trace, such that the electrically conductive icon or artwork layer 2 is electrically connected to the grounding trace to transmit electromagnetic waves into the ground. By virtue of this arrangement, the touch panel may perform its function without being affected by the electromagnetic interference from neighboring equipments, thereby ensuring a stable transmission of touch signals.

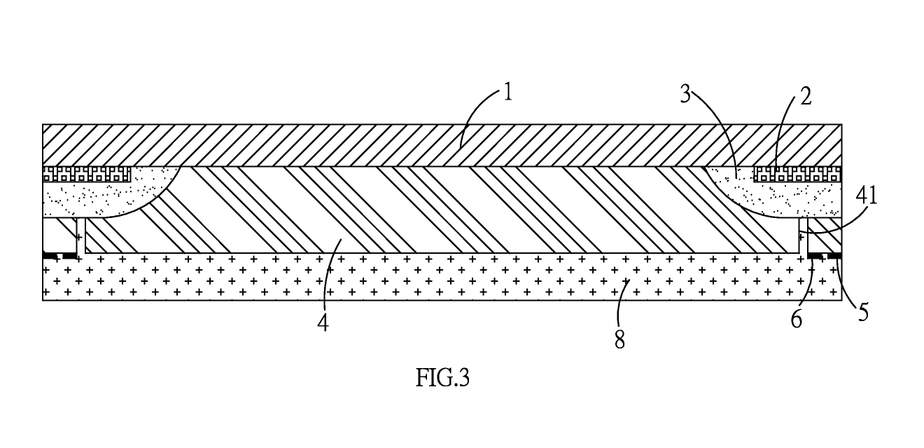

FIG. 3 shows a cross-sectional view of the second preferred embodiment of the invention in which a passivation film is added. This structure is not yet combined with display panel and constitutes only the touch panel. A passivation film 8 may be added on this touch panel prior to combining it with the display panel to protect the touch panel from scratch and damages during combination. The passivation film 8 is formed via printing, spraying, or coating, and its final thickness is less than 20 μm.

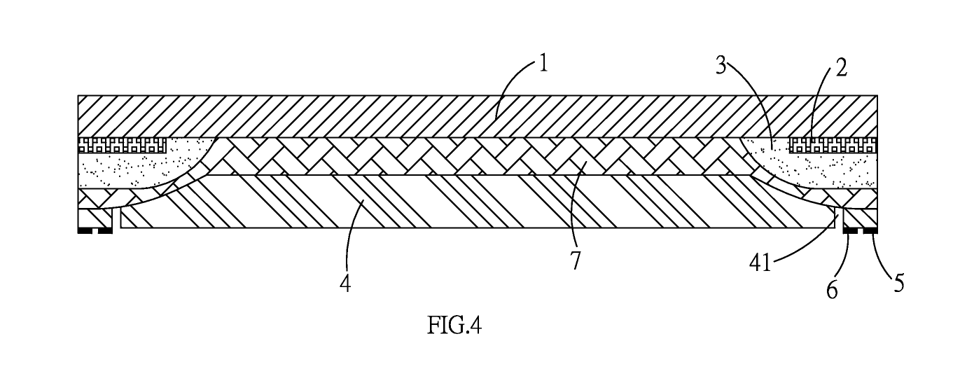

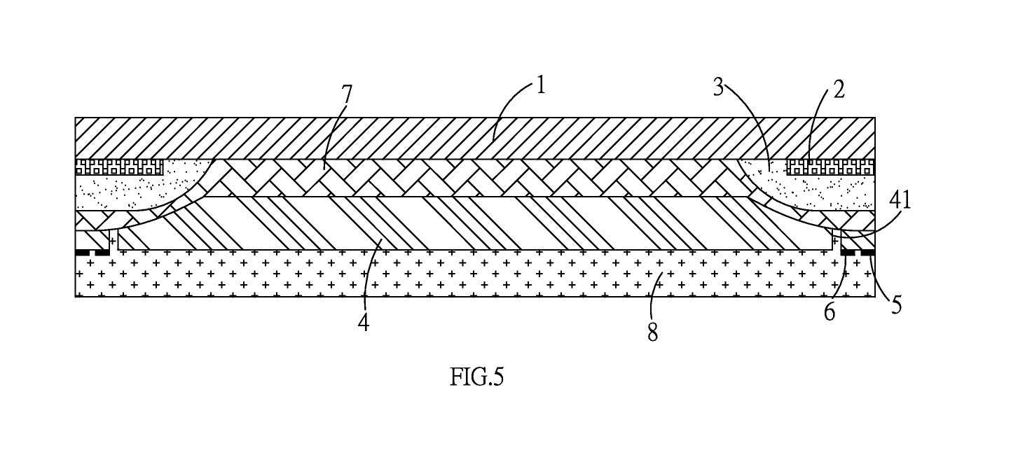

FIG. 4 shows a cross-sectional view of the third preferred embodiment of the invention, and FIG. 5 shows a cross-sectional view of the fourth preferred embodiment of the invention in which the touch panel is added with a passivation film. The structures of these two embodiments are rather similar to that of the abovementioned embodiments. The difference is that in these two embodiments, one side face of the sensing layer 4 is coated with an optical film 7 which covers up the first icon or artwork layer 3 and the areas of the transparent substrate 1 uncoated with the first icon or artwork layer 3. This optical film 7 will minimize visual impairments caused by the uneven circuit slots on the sensing layer 4 produced during circuit etching. The optical film 7 is placed on one side face of the sensing layer 4 via a sputtering, spraying, or coating process. Its thickness is less than 200 nm. The rest of the structures in these embodiments are similar to that of the abovementioned embodiments, and as such, are not repeated here.

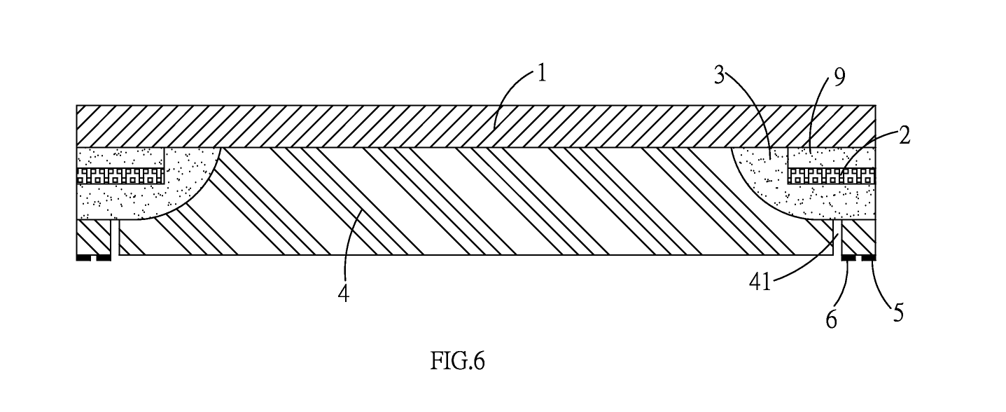

FIG. 6 is a cross-sectional view of the fifth preferred embodiment of the invention. This embodiment is substantially identical in structure to the embodiments described above, except that a second icon or artwork layer 9 is additionally disposed between the transparent substrate 1 and the electrically conductive icon or artwork layer 2. The second icon or artwork layer 9 is juxtaposed to the electrically conductive icon or artwork layer 2. The process and material for manufacturing the second icon or artwork layer 9 are the same as those used for the first icon or artwork layer 3.

It should be noted that the invention is advantageous over the prior art in the following aspects:

1. The electrically conductive icon or artwork layer serves to provide shielding from the ambient electromagnetic fields and further functions as a grounded conductor. The electrically conductive icon or artwork layer imparts an excellent anti-EMI capability to the touch panel, such that the touch panel can perform its function without being affected by the electromagnetic interference from neighboring equipments, thereby ensuring a stable transmission of touch signals.

2. The invention eliminates the conventional step of laminating the transparent substrate and the sensing layer with an optically clear adhesive. Instead, the inner periphery of the icon or artwork layer is not perpendicular to the adjacent line of the transparent substrate, so that complete cladding can be obtained when sputtering the optical film or the sensing layer on it. This overcomes the unevenness produced when the black icon or artwork layer is printed prior to film coating. The yield of the overall structure is thus raised.

3. The icon or artwork layers are formed by sputtering at a low temperature of less than 200° C. Therefore, the quality of the inks used in the icon or artwork layers will not deteriorate and the resistive value of the ITO sensing layer will not alter.

4. One or two layers of optical films are stacked on top and/or bottom of the sensing layer to shield any slots caused by circuit etching. This will prevent the reduction of resolution and the impairment of visual quality.

5. The coating, printing or spraying of the electrode pattern directly on the sensing layer effectively causes the panel to have a reduced thickness and an improved yield rate.

In conclusion, the touch panel with anti-electromagnetic interference capability as disclosed herein can surely achieve the intended objects and effects of the invention. While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A touch panel with anti-electromagnetic interference capability, comprising:
a transparent substrate;
an electrically conductive icon or artwork layer disposed on the periphery of one side face of the transparent substrate;
a first icon or artwork layer coated on the periphery of one side face of the transparent substrate in a manner covering the electrically conductive icon or artwork layer and extending over the periphery of the electrically conductive icon or artwork layer, an inner periphery of the first icon or artwork layer and an adjacent line of the transparent substrate being in a non-perpendicular arrangement;
a sensing layer superimposed on and juxtaposed to the first icon or artwork layer and areas of the transparent substrate uncovered by the first icon or artwork layer;
a metal layout coated on an outer periphery of the sensing layer in corresponding to the mapping location of the first icon or artwork layer; and
an electrode pattern disposed on an inner periphery of the sensing layer by coating, printing or sputtering in a manner corresponding to the mapping location of the first icon or artwork layer and opposite to the position of the metal layout.

2. The touch panel with anti-electromagnetic interference capability according to claim 1, wherein the metal layout comprises a grounding trace, and the first icon or artwork layer is formed with a notch in corresponding to the electrically conductive icon or artwork layer and the grounding trace, such that the electrically conductive icon or artwork layer is electrically connected to the grounding trace.

3. The touch panel with anti-electromagnetic interference capability according to claim 1, wherein the electrically conductive icon or artwork layer is made from an electrically conductive carbon ink.

4. The touch panel with anti-electromagnetic interference capability according to claim 1, wherein the electrically conductive icon or artwork layer is made of a transparent conductive material.

5. The touch panel with anti-electromagnetic interference capability according to claim 1, further comprising a second icon or artwork layer disposed between the transparent substrate and the electrically conductive icon or artwork layer, wherein the second icon or artwork layer is superimposed on and juxtaposed to the electrically conductive icon or artwork layer.

6. The touch panel with anti-electromagnetic interference capability according to claim 1, further comprising a plurality of slots etched on an inner most periphery of the sensing layer in a manner corresponding to the mapping location of the first icon or artwork layer and opposite to the electrode pattern.

7. The touch panel with anti-electromagnetic interference capability according to claim 6, further comprising a passivation film disposed on top of the metal layout and the electrode pattern and filled within the slots.

8. The touch panel with anti-electromagnetic interference capability according to claim 1, wherein the touch panel is manufactured at a temperature maintained below 200° C. at all time.

9. A touch panel with anti-electromagnetic interference capability, comprising:
a transparent substrate;
an electrically conductive icon or artwork layer disposed on the periphery of one side face of the transparent substrate;
a first icon or artwork layer coated on the periphery of one side face of the transparent substrate in a manner covering the electrically conductive icon or artwork layer and extending over the periphery of the electrically conductive icon or artwork layer, an inner periphery of the first icon or artwork layer and an adjacent line of the transparent substrate being in a non-perpendicular arrangement;
an optical film superimposed on and juxtaposed to the first icon or artwork layer and areas of the transparent substrate uncovered by the first icon or artwork layer;
a sensing layer superimposed on and juxtaposed to the optical film;
a metal layout coated on an outer periphery of the sensing layer in corresponding to the mapping location of the first icon or artwork layer, the metal layout comprising a plurality of metal traces; and
an electrode pattern disposed on an inner periphery of the sensing layer by coating, printing or sputtering in a manner corresponding to the mapping location of the first icon or artwork layer and opposite to the position of the metal layout.

10. The touch panel with anti-electromagnetic interference capability according to claim 9, wherein the metal layout comprises a grounding trace, and the first icon or artwork layer is formed with a notch in corresponding to the electrically conductive icon or artwork layer and the grounding trace, such that the electrically conductive icon or artwork layer is electrically connected to the grounding trace.

11. The touch panel with anti-electromagnetic interference capability according to claim 9, wherein the electrically conductive icon or artwork layer is made from an electrically conductive carbon ink.

12. The touch panel with anti-electromagnetic interference capability according to claim 9, wherein the electrically conductive icon or artwork layer is made of a transparent conductive material.

13. The touch panel with anti-electromagnetic interference capability according to claim 9, further comprising a second icon or artwork layer disposed between the transparent substrate and the electrically conductive icon or artwork layer, wherein the second icon or artwork layer is superimposed on and juxtaposed to the electrically conductive icon or artwork layer.

14. The touch panel with anti-electromagnetic interference capability according to claim 9, further comprising a plurality of slots etched on an inner most periphery of the sensing layer in a manner corresponding to the mapping location of the first icon or artwork layer and opposite to the electrode pattern.

15. The touch panel with anti-electromagnetic interference capability according to claim 14, further comprising a passivation film disposed on top of the metal layout and the electrode pattern and filled within the slots.

16. The touch panel with anti-electromagnetic interference capability according to claim 9, wherein the touch panel is manufactured at a temperature maintained below 200° C. at all time.
